(19) United States
(12) Patent Application Publication
(10) Pub. No.: US 2011/0126385 A1
(43) Pub. Date: Jun. 2, 2011

(54) Security Clasp

(76) Inventors: Nathan MARTIN, Baltimore, MD (US); Eric B. WARD, Westminster, MD (US)

(21) Appl. No.: 12/947,461

(22) Filed: Nov. 16, 2010

Related U.S. Application Data
(60) Provisional application No. 61/261,940, filed on Nov. 17, 2009.

(51) Int. Cl. F16B 2/02; F16B 7/00

(52) U.S. Cl. 24/457; 403/361

(57) ABSTRACT

One aspect of the present invention includes a first component that includes a solid body including a first and second aperture, a lip, and a groove. Also included is a second component that also includes an aperture corresponding to the first aperture of the first component. The second component is preferably operatively connected to and slidingly engageable with the first component. Finally, a third component is also included having a first end movably connected to the first component and a second free end operable to be engaged with the second aperture formed in the first component. When the free end of the third component is positioned within the second aperture of the first component, and when the second component is engaged with the lip and the groove of the first component, a flange of the second component prevents the free end of the third component from being removed from the second aperture of the first component.

### CROSS-REFERENCE TO RELATED APPLICATIONS

This application claims priority to U.S. Provisional Application Ser. No. 61/261,940, filed on Nov. 17, 2009, the entirety of which is incorporated herein by reference.

### FIELD OF THE INVENTION

The present invention generally relates to a security clasp. More specifically, the present invention relates to a multi-component security clasp that includes an aperture through which an object may pass, enabling the object to be secured to another object.

### BACKGROUND OF THE INVENTION

Various locking mechanisms are well known in the prior art. Each of the locking mechanisms of the prior art use an age old system that employs a lock body, a locking mechanism attached to the lock body, and a shackle. In operation, the shackle is typically placed into an opening in the lock body that allows the locking mechanism to engage, securing the shackle within the lock body. In order to disengage the shackle, a key is required to disengage the locking mechanism, allowing the shackle to be removed from the lock body.

Various modifications of this general concept have been developed over the years. One common characteristic of all prior art locks, however, is that the lock body has a variety of moving parts, including or in addition to the locking mechanism, that are required to secure the shackle. The problem with these prior art locks is that their moving mechanisms are susceptible to break down due to repeated use, weather, or other outside or environmental factors. Additionally, the use of internal moving parts with prior art locks makes them more expensive to conceive, design, test, and maintain.

Therefore, a continuing need exists for an apparatus, system, and method that reduces the number of moving parts, e.g., internal moving parts, while simplifying their design and use.

### SUMMARY OF THE INVENTION

According to one aspect, the present invention comprises a security clasp. The security clasp includes a first component comprising a solid body including a first and second aperture, a lip, and a groove. Also included is a second component including an aperture corresponding to the first aperture of the first component. The second component may be operatively connected to, and slidingly engageable with, the first component. In addition, a third component is included that comprises a first end movably connected to the first component and a second free end operable to be engaged with a second aperture formed in the first component. When the free end of the third component is positioned within the second aperture of the first component, and when the second component is engaged with the lip and the groove of the first component, a flange of the second component prevents the free end of the third component from being removed from the second aperture of the first component.

In one embodiment, the second component further comprises a first aperture and a second aperture. The center of the first aperture of the second component aligns with the center of the first aperture of the first component when the security clasp is in the closed position. The first component may be rectangular, while the first aperture of the first component and the first aperture of the second component may be circular.

According to another aspect, the present invention may include a first component comprising a body having an aperture therein. The body may also have a first receptacle formed in an outer edge of the body. In addition, a second component may be operatively connected to the first component. The second component also includes a protrusion and an aperture substantially similar to the aperture in the body of the first component. Finally, a third component is also included that comprises a first end that is housed within a portion of an inner cavity of the body of the first component, and a second end that is configured and dimensioned to fit within the first receptacle of the body of the first component. The protrusion of the second component may obstruct the first receptacle of the body when the aperture of the second component is substantially aligned with the aperture of the body,

The first component, according to one aspect, further comprises a second receptacle that is operable to house a portion of the second component. This aspect of the present invention may also include an obstruction item operable to pass through the aperture of the first component and the aperture of the second component. The obstruction item may prevent movement of the second component when it is passed through the aperture of the first component and the aperture of the second component.

In one embodiment, the first component may be formed out of a material selected from the list comprising metal, plastic, rubber, wood, alloys, nanomaterials, and combinations thereof. The second end of the third component may be operable to move within the first receptacle of the body when the protrusion obstructs the first receptacle of the body. However, the first end of the third component preferably has a range of motion about at least one axis. Although the second receptacle may be formed in any desirable manner, it may comprise a protrusion from the surface of the body. The third component may comprise a “U” shape.

In yet another embodiment, the apparatus of the present invention includes a first component, a second component, and a third component. The first component comprises a solid body with a first and second aperture, and a lip that extends in a parallel manner above the face of the first component. The second component comprises a solid guard plate with a first and second aperture movably connected to the exterior of the first component at the second aperture. Finally, the third component comprises a shackle movably connected to the first component. The security clasp may be operable to be maintained in at least an open position and a closed position, and the first component further comprises an opening positioned to receive the free leg of the third component.

According to this aspect, the second component at least partially covers the opening in the first component when the security clasp is in the closed position. The diameter of the first aperture of the guard plate and the diameter of the first aperture of the first component is between about 1 centimeter and about 20 centimeters. In such an embodiment, the first component and the second component may both be asymmetrical in shape. However, the first aperture of the first component and the first aperture of the second component may be circular.

### BRIEF DESCRIPTION OF THE DRAWINGS

Further features and advantages of the invention can be ascertained from the following detailed description that is provided in connection with the drawings described below:

FIG. 1 shows different perspective views of one exemplary embodiment of a security clasp of the present invention;

FIG. 2 shows various perspective views of the exemplary embodiment shown in FIG. 1;

FIG. 3 shows one aspect of the present invention in the “locked” position using an obstruction item; and

FIG. 4 shows multiple items being secured to one another using one exemplary aspect of the present invention.

### DETAILED DESCRIPTION OF THE PREFERRED EMBODIMENTS

Locks are used for many different reasons, in a variety of applications. Generally, however, a lock secures one item to another or prevents the separation of two or more items. As discussed above, prior art locking mechanisms have internal movable parts that act to secure a shackle within the lock body.

One aspect of the present invention includes a security clasp that is formed by multiple components and has at least two positions, e.g., open and closed. The security clasp may be used in a variety of applications to attach one object to another. An aperture in the lock body allows an object to pass through to act as an obstruction item. When the security clasp is in the closed position, the obstruction item may be passed through the aperture in order to prevent the clasp from moving to the open position. In other words, the security clasp of the present invention may be locked without requiring any locking mechanism within the lock body.

The security clasp of the present invention preferably includes three components. Generally, the first component of the present invention forms a body or housing, the second component of the present invention forms a plate or solid structure that may be optionally attached to the interior or exterior of the first component, and third component of the present invention forms a fastener or shackle.

According to one aspect, the first component generally comprises a body having an aperture therein through which an object may pass. It is desirable for the first component to include a stopping surface or receptacle. The stopping surface or receptacle may be configured and dimensioned to receive and house a second object. The stopping surface or receptacle may be formed in any desirable manner. In a simpler embodiment, the stopping surface or receptacle may comprise a protrusion extending from a surface of the first component. The protrusion may be configured and dimensioned as desired. The first component also includes a receptacle, second aperture, or indentation in one surface of its body. The receptacle preferably does not pass completely through the body of the first component. It may be desirable for the receptacle to be selectively positioned near an outer edge of the first component.

According to one aspect, a second component is preferably operatively connected to the first component, and also has an aperture through which an object may pass. The aperture may comprise any dimensions, although it preferably corresponds to the aperture in the first component. The second component may be engaged with the first component such that it is operable to move in at least one direction with respect to the first component. At least a portion of the second component may include a flange or protrusion. In a first position, when the second component is operatively connected to the first component, the receptacle (second aperture) in the first component is unobstructed. However, in a second position, when the second component is operatively connected to the first component, the flange or protrusion of the second component may obstruct or block the receptacle (second aperture) of the first component. In the second position, the flange or protrusion of the second component may prevent an object placed inside the receptacle from being removed.

In one embodiment, the third component comprises any object having two open ends. Preferably, the third component comprises a bar that may be bent into a “U” shape. At one end, the third component is attached to one side of the first component. The attachment may be accomplished in any desired manner, and preferably allows for a range of motion about at least one axis. At least a portion of the end of the third component that is attached to the first component may reside within an internal cavity of the first component. The third component may be prevented from being completely removed from the cavity by any means known to those skilled in the art.

The other end of the third component preferably remains free, and is not fixedly attached to any surface. However, the free end of the third component may optionally be positioned within the receptacle of the first component. As such, the receptacle of the first component is preferably configured and dimensioned such that it can house the free end of the third component, and vice versa. When the free end is positioned within the receptacle of the first component, and the second component is positioned such that a portion of it obstructs the receptacle, the free end is prevented from leaving the receptacle. When positioned as such, one aspect of the present invention may be considered “locked.” While in the “locked” position, the free end of the third component may be prevented from moving. However, in alternate embodiments, the free end of the third component may be capable of moving within the confines of the receptacle, although it may not leave the receptacle.

In operation, the free end of the third component may be inserted through an opening of any sort in any desired object, e.g., a handle, hole, or the like, in order to secure the object. Optionally, the free end of the third component may be inserted through openings in two or more objects in order to secure the objects to one another. After being inserted through openings in one or more objects, the free end of the third component may be positioned within the receptacle of the first component. Then, the second component may be positioned such that a portion of the second component obstructs the receptacle, thereby securing the free end within the receptacle.

As discussed herein, the first component may include a stopping surface or receptacle for housing a portion of the second component. The stopping surface or receptacle may include an interference fit that aids to maintain the second component within the receptacle, i.e., in the locked position. As a further preventative measure, an obstruction item may pass through the apertures in the first and second components to further prevent or reduce movement of the second component out of the stopping surface or receptacle. The flange or protrusion of the second component is configured and dimensioned such that it blocks the receptacle of the first component in which the free end of the third component is housed, thereby “locking” the device. Because the obstruction item prevents the second component from moving positions enough to prevent the flange or protrusion from blocking the receptacle of the first component (in which the free end of the third component is housed), the clasp of the present invention may be prevented from being “unlocked”, i.e., the flange or protrusion of the second component cannot be moved into a position where it does not obstruct the receptacle.

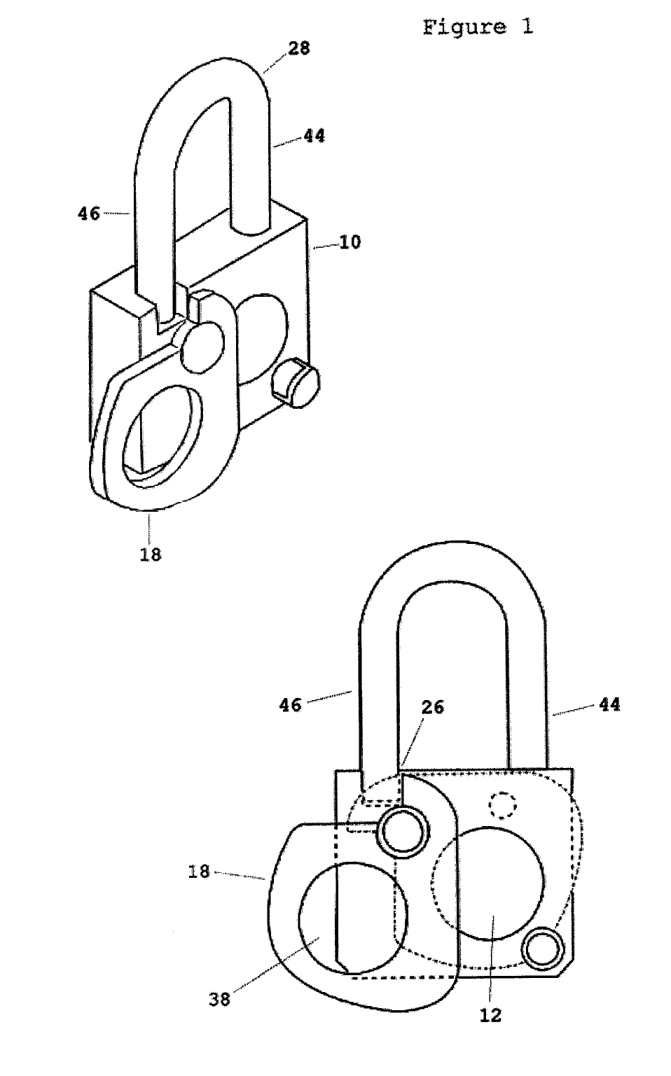

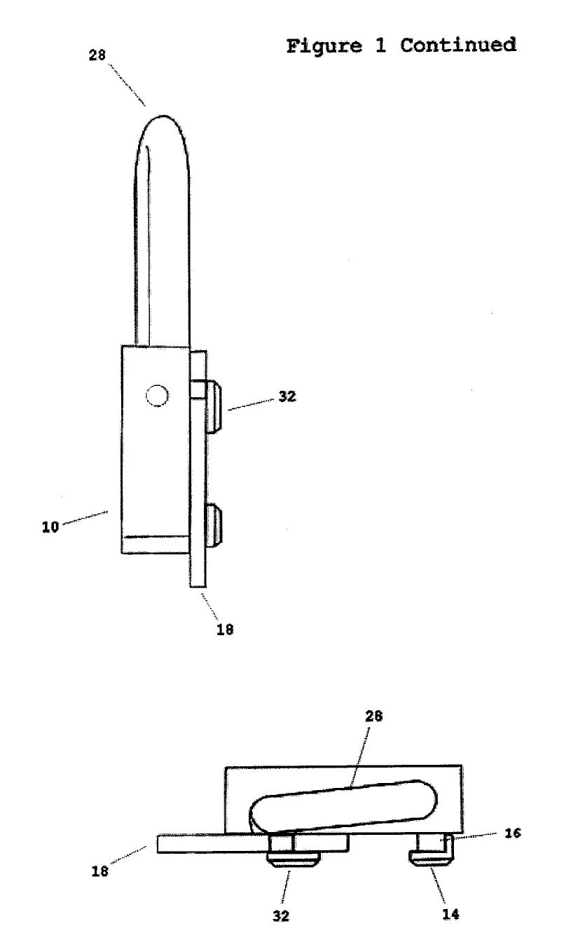

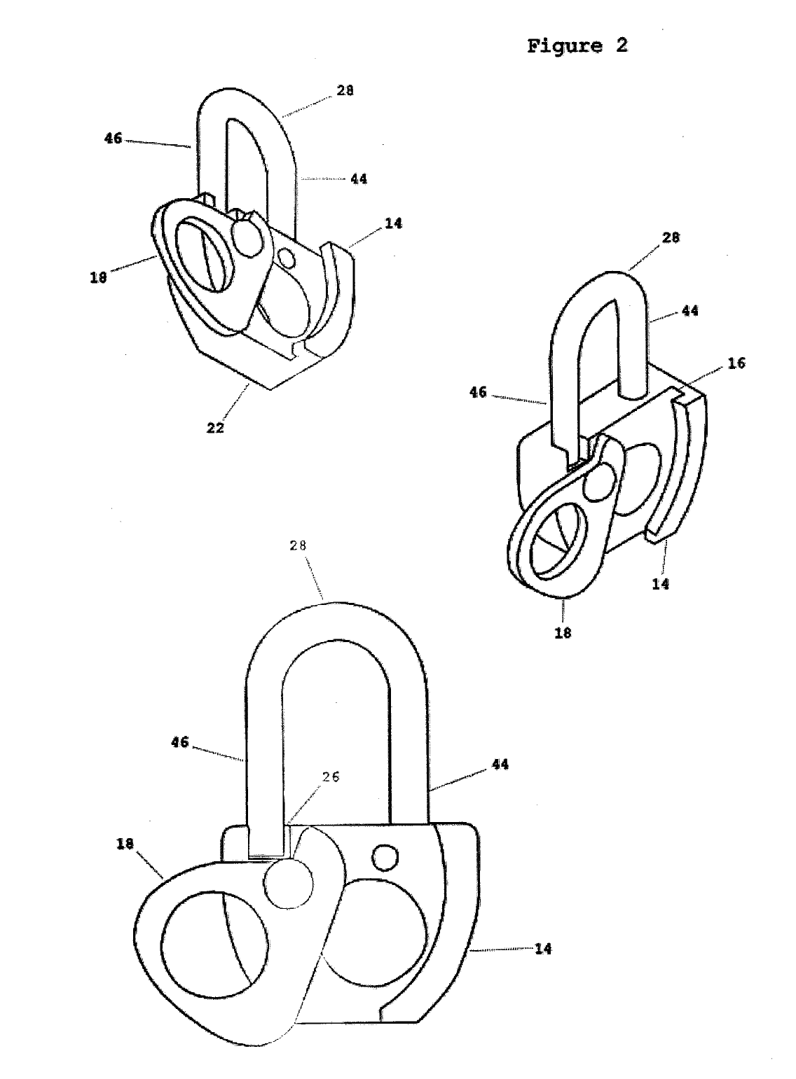

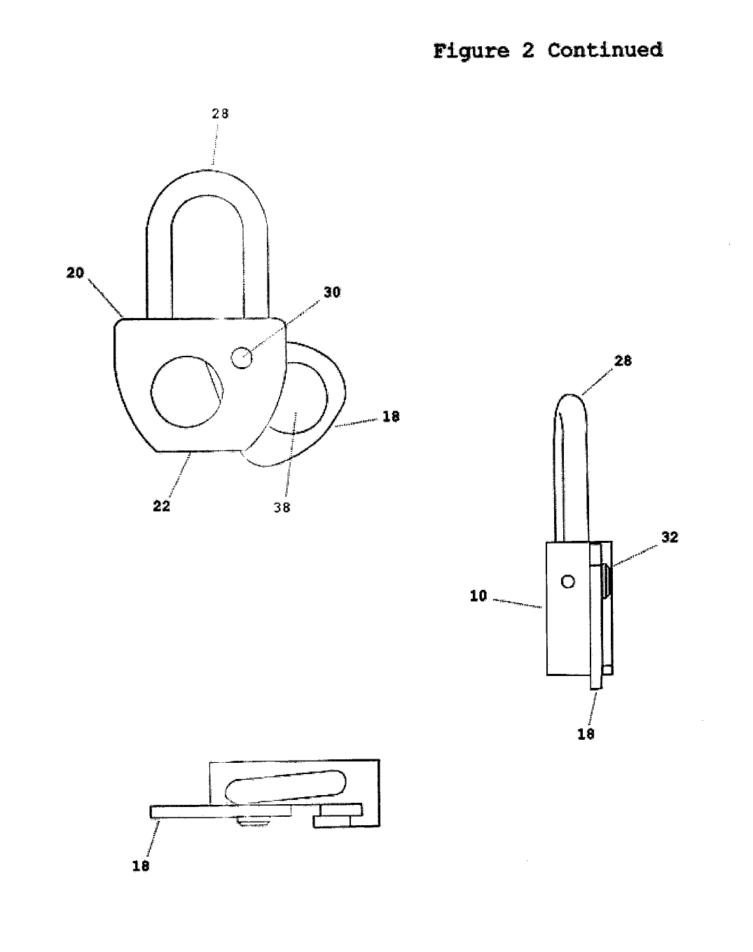

With reference to FIG. 1, one aspect of the present invention is described. In one embodiment of the present invention, the first component 10 comprises a solid body with a primary aperture 12 through its face. One side of component 10 includes a lip 14 that includes a groove 16, shown in FIG. 2. It is desirable for the lip 14 and groove 16 to extend in a parallel manner above the face of component 10. In other words, the lip 14 and groove 16 extend away from one face of component 10. The lip 14 and groove 16 may be configured and dimensioned to support the second component 18 or guard plate on the exterior of the first component, which in turn is configured and dimensioned to fit into the groove 16.

As mentioned above, the component 10 may comprise a solid body in one embodiment. The solid body may be made out of any material, such a metal, plastic, alloys, composites, rubber, nanomaterials, or wood. Regardless of the material used to form the solid body, it is desirable for the component 10 to be formed of a high strength, low weight material. One advantage of forming the component 10 in this manner is that is may be easily transported, and can be used in weight sensitive application, e.g., space applications where increased weight results in increased costs. The high strength of the component 10 prevents its structural integrity from being compromised, either during applications when large stresses are exerted on the security clasp for short periods of time or due to wear and tear over longer periods of time.

In other cost sensitive applications, the component 10 may be formed from any material that is operable to maintain the structural integrity of the lock. Optionally, the component 10 may be formed from a material that has a greater structural integrity than the components with which it is expected to be used. For example, if the obstruction item is plastic and the item to be secured (passed through the fastener 28) is also plastic, the component 10 may be formed from a material that has a higher structural integrity than plastic, e.g., metal or other alloys.

The dimensions of the component 10 may also be varied as desired, and may depend on the particular application with which it is being used. For instance, if the security clasp is being used in a large scale application, e.g., undersea cables, the size of the component 10 may be large. In other applications, for instance when the present invention is used with fiber optic cables within a residence, the size of the component 10 may be smaller. In any event, the present invention is not intended to be limited to any particular dimensions, and may include any size, shape, height, width, or volume known to those skilled in the art.

The size of the aperture 12 may similarly be varied as desired, and may also depend on the application with which it is being used and/or the size of the component 10. For example, the size of the aperture may be proportional to the size of the component 10. Alternately, the size of the aperture 12 may be independent of the size of the component 10. In other embodiments, the aperture 12 may be dependent on the size, e.g., diameter, of the obstruction item. Having an aperture 12 that is independent of the size of the component 10 may be useful in applications where the size of the obstruction item is small but the size or number of items that need to be secured is large.

The dimensions of the aperture may be modified as desired. It may be desirable, for example, to modify the shape of the aperture. The shape can be based on a particular application in which the present invention is being used, and may depend on the dimensions of the obstruction item. The shape of the aperture may comprise, but is not limited to, circular, oval, square, rectangular, triangular, hexagonal, heptagonal, irregular, or any other shape known to those skilled in the art.

In any event, the dimensions of the aperture may be varied as desired, without limitation. One way to describe the dimensions of a circular aperture is by its diameter. In one embodiment, the diameter of the circular aperture is preferably between about 1 centimeters and about 20 centimeters. More preferably, the diameter of the circular aperture is between about 2 centimeters and about 15 centimeters. Most preferably, the diameter of the circular aperture is between about 3 centimeters and about 10 centimeters.

In another embodiment, the diameter of the circular aperture is preferably greater than 2 centimeters. More preferably, the diameter of the circular aperture is greater than about 10 centimeters. Most preferably, the diameter of the circular aperture is greater than about 30 centimeters. Alternately, the diameter of the circular aperture is preferably less than 50 centimeters. More preferably, the diameter of the circular aperture is less than about 30 centimeters. Most preferably, the diameter of the circular aperture is less than about 20 centimeters.

The aperture 12 may be selectively positioned in any portion of the component 10. One way to describe the position of the aperture 12 is based on a center line axis of the component 10. This assumes, of course, that the component 10 is symmetrical. Even when the component 10 is not symmetrical, and regardless of the shape of the component 10, for the purposes of this description the center line axis of the component 10 is considered to be an imaginary axis extending from the center point of the top 20 of the component 10 towards the bottom 22 of the component. Also for the purposes of this description, the center of the aperture 12 may be determined geometrically based on its shape, and with respect to an imaginary horizontal axis extending from the left to the right of the component 10. This applies even if the aperture 12 comprises an irregular shape.

When the aperture 12 is circular, it may be bisected by the center line of the component 10. In another aspect, however, it may be desirable to position the aperture away from the center of the component 10. The position of the aperture 12 with respect to the center line may be described in terms of the distance the center of the aperture 12 deviates with respect to the center line. In one aspect, the center of the aperture 12 is about 5 centimeters or less away from the center line of the component 10. Most preferably, the center of the aperture 12 is about 3 centimeters or less away from the center line of the component 10.

In another embodiment, the center of the aperture 12 is preferably between about 1 millimeter and about 30 centimeters away from the center line of the component 10. More preferably, the center of the aperture 12 is between about 1 centimeter and about 20 centimeters away from the center line of the component 10. Most preferably, the center of the aperture 12 is between about 1 centimeter and 10 centimeters away from the center line of the component 10. Alternately, the center of the aperture 12 is preferably less than about 50 centimeters away from the center line of the component 10. More preferably, the center of the aperture 12 is less than about 20 centimeters away from the center line of the component 10. Most preferably, the center of the aperture 12 is less than about 10 centimeters away from the center line of the component 10.

In a similar manner, the lip 14 and groove 16 may be configured and dimensioned in any desired manner. The lip 14 is formed and positioned towards one end of the component 10 such that it can receive the guard plate 18. The lip 14, as shown in FIG. 1, is spaced apart from a face of the component 10, thereby forming the groove 16. In addition to being able to receive the guard plate 18, the lip, in combination with the groove 16, serves to restrict the motion of the guard plate in at least one direction. In other words, the guard plate 18, once positioned in the groove 16, is prevented from further movement in at least one direction by the combination of the lip 14 and groove 16. Along these lines, the lip 14 and groove 16 extend away from the face of the component 10 in a substantially parallel manner. Additionally, the lip 14 and groove 16 are configured to comprise substantially the same shape.

As an example, FIGS. 1 and 2 show the lip 14 and groove 16 extending in a substantially parallel manner away from the face of component 10. FIGS. 1 and 2 also shows a three-dimensional view of component 10 that reveals this feature, along with the lip 14 and groove 16, which in the FIG. 2 embodiment comprise a crescent shape. In other words, the matching crescent shape of the lip 14 and groove 16 is what is referred to herein as being substantially parallel and having substantially the same shape. Of course, those skilled in the art will understand that the FIG. 2 embodiment is for illustrative purposes only. The lip 14 and groove 16 may comprise any dimensions in accordance with the description herein.

For example, in one aspect the lip 14 and groove 16 may be configured and dimensioned such that it comprises the shape of an outer edge of the component 10. As shown in FIG. 1, for instance, the outer edge of component 10 is slightly curved into the crescent shape. Thus, the lip 14 and groove 16 are also formed in a substantially similar manner. Alternately, the lip 14 and groove 16 may not comprise the same shape, angle, curvature, or other dimensions as the outer edge of component 10. Such an embodiment may be desirable if the shape of the outer edge of component 10 is not operable to receive the guard plate 18.

The lip 14 and the groove 16 may alternately be configured and dimensioned such that they extend beyond the boundary formed by the edges of the component 10. In such an embodiment, the lip 14 and groove 16 may protrude beyond the outer edge of component 10. In another aspect, the lip 14 and groove 16 may be configured and dimensioned such that they only receive a portion of the guard plate 18.

It may be desirable to configure and dimension the lip 14 to be separated from the surface 24 of the component 10 by a desired amount. For instance, in one aspect the lip 14 may preferably be separated from the surface 24 of the component 10 by about 10 mm or less. More preferably, the lip 14 is separated from the surface 24 of the component 10 by about 7 mm or less. Most preferably, the lip 14 is separated from the surface 24 of the component 10 by about 5 mm or less.

According to another embodiment, the lip 14 may preferably be raised separated from the surface 24 of the component 10 between about 1 millimeter and about 5 centimeters. More preferably, the lip 14 is separated from the surface 24 of the component 10 between about 1 millimeter and about 3 centimeters. Most preferably, the lip 14 is separated from the surface 24 of the component 10 by between about 1 millimeter and about 2 centimeters. In yet another embodiment, the lip 14 may preferably be separated from the surface 24 of the component 10 by less than about 10 centimeters. More preferably, the lip 14 may be separated from the surface 24 of component 10 by less than about 5 centimeters. Most preferably, the lip 14 may be separated from the surface 24 of component 10 by less than about 3 centimeters.

In one aspect, the lip 14 and the groove 16 comprise substantially the same shape, and thus in this aspect the height of the groove 16 corresponds to the distance that the lip 14 is separated from the front surface 24 of component 10. The depth of groove 16, however, may also be varied as desired. While skilled artisans may consider any number of factors when determining the appropriate depth of the groove 16, one factor that should be considered is the dimension of the guard plate 18. Specifically, one advantage of the lip 14 and groove 16 is that they serve to restrict the movement of the guard plate 18. Thus, the dimensions of the guard plate 18 may factor into the depth of the groove 16.

In one aspect, the depth of the groove 16 is preferably between about 0.1 millimeter and about 2 centimeters. More preferably, the depth of the groove 16 is between about 0.5 millimeters and about 1 centimeter. Most preferably, the depth of the groove 16 is between about 1 millimeter and about 5 millimeters. Other embodiments may preferably have a groove 16 depth of about 0.1 millimeters or greater. More preferably, the groove depth may be about 1 millimeter or greater. Most preferably, the groove depth may be about 1 centimeter or greater. Alternately, the depth of the groove 16 is preferably about 3 centimeters or less. More preferably, the depth of the groove 16 is about 2 centimeters or less. Most preferably, the depth of the groove 16 is about 1 centimeter or less.

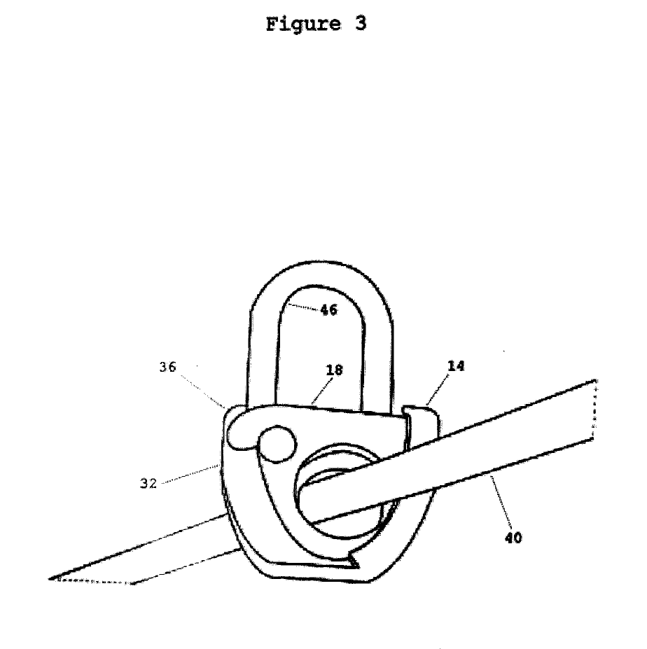

The component 10 also includes a slot or opening 26 formed in its top 20 portion. The opening is selectively positioned to receive one leg (the free leg 46) of the fastener 28, and an adjacent opening (not shown) in the top 20 portion of component 10 is configured to hold a portion of the other leg of the fastener (the rooted leg 44) within a portion of the inside of the component 10, as shown in FIGS. 1 and 3. One example of a fastener 28 that can be used in accordance with the present invention is shown in FIGS. 1-3.

The opening 26, in accordance with the present invention, may comprise any desired dimensions. Preferably, the opening 26 is dimensioned to be substantially the same size as, or larger than, the free leg of the fastener 28, which will be described in more detail below. In any event, the opening 26 is preferably formed such that it comprises a receptacle that houses the free leg 46 of the fastener 28. Along these lines, the opening 26 should be formed such that it can receive and house the free leg 46 of the fastener 28, but prevent the leg from passing completely through the component 10, as shown in FIGS. 1-3. In other words, the opening 26 should not pass completely through the body of component 10.

The depth of the opening 26 should be selected such that it can receive the free leg 46 of the fastener 28 when it has been positioned within the opening 26. It is important that the depth of the opening 26 is sufficient to prevent the free leg 46 of the fastener 28 from being withdrawn or otherwise removed from the opening when it is in the closed position (described below), e.g., by applying force in small amounts.

The second opening in which the rooted leg 44 of the fastener 28 is inserted preferably prevents the fastener 28 leg 44 from being completely withdrawn from an internal portion of the component 10. This may be accomplished using any method known to those skilled in the art. However, the opening should be configured and dimensioned such that the rooted leg 44 of the fastener 28 can rotate about an imaginary vertical axis, e.g., an axis passing from the top 20 to the bottom of the component 10. In one embodiment, the opening 26 may allow only rotational movement, which prevents movement up and down the vertical axis. However, in other embodiments it may desirable for the opening to allow both vertical and rotational movement of the rooted leg 44. Regardless of the type of movement allowed, the opening preferably prevents the rooted leg 44 of the fastener from being completely removed during normal operation.

One way to describe the rotational movement allowed by the opening 26 is with respect to the degree of rotation that it allows. Describing the rotational movement in this manner does not account for the fact that the opening 26 would partially prevent movement in a certain direction. Rather, the description herein relates to the possible degrees of movement absent such obstructions. In one aspect, the opening preferably allows the fastener 28 to rotate about 180 degrees or more. More preferably, the opening allows the fastener 28 to rotate about 200 degrees or more. Most preferably, the opening allows the fastener 28 to rotate about 350 degrees or more.

The fastener 28 may also comprise any desired dimensions. One example of a desirable shape of the fastener is shown in FIGS. 1 and 3, where the fastener comprises an upside down “U” shape. The fastener 28 shown in FIGS. 1 and 3 is for illustrative purposes only, and is not intended to limit the present invention. For instance, the shape of the fastener 28 may be selected based on the desired type of object with which it will be used. If the present invention is intended to be used to with a square shaped object, it may be desirable for the fastener 28 to be comprise three sides of a square. Other factors, such as reducing the amount of space taken up by the present invention, may be factored into selecting the shape of the fastener 28.

Shapes that may be used include, but are not limited to, the “U” shape, triangular, square, pentagonal, hexagonal, heptagonal, or the like. Of course, those skilled in the art will understand that when triangular, square, pentagonal, hexagonal, or heptagonal shapes are used, one side of the shape will necessarily be missing because at least one end of the fastener may be inserted into the interior of the body of component 10. Other irregular shapes may also be used, if desired.

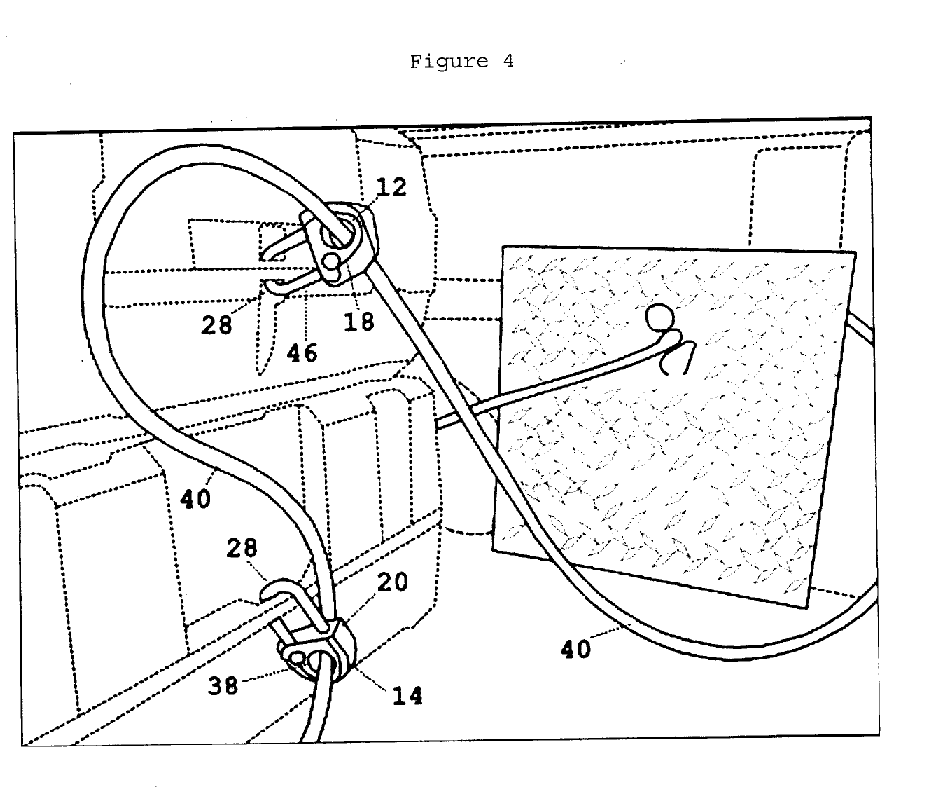

The component 10 also includes an additional aperture 30, shown in FIG. 4. The aperture preferably passes completely through the component 10, and may comprise any desired dimensions. The dimensions of the aperture 30 are preferably smaller than the aperture 12 discussed earlier, although certain aspects may be similar. For instance, the aperture 30 may comprise any of the shapes discussed above with respect to aperture 12.

It will be understood that the dimensions of the aperture 30 may be varied as desired, without limitation. Relative to the dimensions of aperture 12, however, the dimensions of aperture 30 are preferably smaller. One way to describe the dimensions of a circular aperture is by its diameter. In one embodiment, the diameter of the aperture 30 is preferably between about 3 millimeters and about 20 millimeters. More preferably, the diameter of the aperture 30 is between about 3 millimeters and about 15 millimeters. Most preferably, the diameter of the aperture 30 is between about 3 millimeters and about 10 millimeters.

In another embodiment, the diameter of the aperture 30 is preferably greater than 2 millimeters. More preferably, the diameter of the aperture 30 is greater than about 10 millimeters. Most preferably, the diameter of the aperture 30 is greater than about 30 millimeters. Alternately, the diameter of the aperture 30 is preferably less than 50 millimeters. More preferably, the diameter of the aperture 30 is less than about 30 millimeters. Most preferably, the diameter of the aperture 30 is less than about 20 millimeters.

Another way to describe the dimensions of aperture 30 is with respect to the dimension of aperture 12. When both apertures comprise the same shape, the ratio of the size, e.g., length, width, height, diameter, or area, of aperture 30 to aperture 12 may be described. For instance, it may be preferable for the ratio of the size of aperture 12 to the size of aperture 30 to be about 10:1 or greater. More preferably, the ratio of the size of aperture 12 to the size of aperture 30 is about 20:1 or greater. Most preferably, the ratio of the size of aperture 12 to the size of aperture 30 is about 30:1 or greater.

In another aspect, the ratio of the size of aperture 12 to the size of aperture 30 is preferably between about 100:1 and about 5:1. More preferably, the ratio of the size of the aperture 12 to the size of the aperture 30 is between about 75:1 and about 10:1. Most preferably, the ratio of the size of aperture 12 to the size of aperture 30 is between about 50:1 and about 20:1. Alternately, the ratio of the size of aperture 12 to the size of aperture 30 is about 150:1 or less. More preferably, the ratio of the size of aperture 12 to the size of aperture 30 is about 100:1 or less. Most preferably, the ratio of the size of the aperture 12 to the size of aperture 30 is about 75:1 or less.

The aperture 30 is preferably positioned to receive a pin 32, which passes through the aperture 30, in order to operatively connect the guard plate 18 to the front surface 24 of the component 10, as shown in FIGS. 1-3. The pin 32 may be shaped such that it fits within the aperture 30, and can have dimensions that match those of the aperture 30. It may be desirable, however, for the pin 32 to comprise slightly smaller dimensions such that it is operable to fit through the aperture 30, as also shown in FIGS. 1-2.

It is desirable for the pin 32 to be fixedly secured within the aperture. This may be accomplished in any desired manner, using any fastener known to those skilled in the art. For example, a mechanical fastener, glue, epoxy, or other adhesive may be used. Alternately, the pin 32 may be secured within the aperture 30 by welding, or any other process known to those skilled in the art.

When the pin 32 is used to secure the guard plate 18 to the front face 20 of the component 10, the guard plate 18 is preferably able to rotate about the pin 32. As such, it may not be desirable to fixedly attach the guard plate 18 to the pin 32. The guard plate 18 is preferably able to rotate in at least one direction, although it may be operable to rotate in two directions according to a particular application. Naturally, the guard plate 18 includes an aperture that allows the pin to pass through it, allowing it to be secured to the front face 20 of the component 10.

As shown in FIGS. 1-2, the guard plate 18 may be formed having any desired dimensions. The guard plate 18 may include an aperture 34 that comprises substantially the same shape and dimensions as the aperture 12 included in component 10. As discussed above, the guard plate 18 is configured and dimensioned such that a portion of it fits inside the lip 14 and groove 16 of the component 10. Although the dimensions of the guard plate 18 may be varied, they are preferably selected such that they account for the dimensions of the other elements of the present invention discussed above.

In one aspect, the lip 14 and groove 16 preferably prevent movement of the lip once it is moved in a counterclockwise direction and is fit into the lip 14 and groove 16. However, in other embodiments it may be desirable to allow the guard plate 18 to slidingly engage with the lip 14 and groove 16 such that it can continue rotating counterclockwise. It may alternately be desirable for the lip 14 and groove 16 to comprise an interference fit that, once the guard plate 18 has been rotated into position in the groove 16, prevents further rotation unless a threshold mechanical force is applied to continue the rotation.

The guard plate 18 also includes an extension 36, e.g., a hook or flange, that extends over the opening 26 when the other portions of the guard plate 18 are engaged with the lip 14 and groove 16, e.g., it is in the closed position. The flange 36 may comprise any dimensions, but is preferably operable to prevent the movement of the free leg 46 of the fastener 28 from moving when it is housed in the opening 26 and the guard plate 18 is in the closed position.

As described above, the present invention includes two positions: (i) open; and (ii) closed. When the guard plate 18 is in the “open” position, the flange 36 does not obstruct the opening 26 in the component 10 (shown in FIG. 2). Accordingly, the free leg 46 of fastener 28 is free to move into, and out of, opening 26. In order the place the security clasp of the present invention into the “closed” position, the free leg 46 of the fastener 28 is positioned into the opening 26 of component 10. Then, the guard plate 18 is rotated about pin 32 such that it is engaged with the lip 14 and groove 16 (shown in FIG. 2). When the guard plate 18 is positioned as such, the flange 36 of the guard plate 18 obstructs the opening 26 of component 10, and thereby prevents the movement of the free leg 46 of fastener 28 out of the opening 26, as shown in FIG. 3. In this manner, two items may be secured to one another.

The security clasp of the present invention is maintained in a closed position by an obstruction item 40, an example of which is shown in FIG. 3. Obstruction items appropriate for use with the present invention include, but are not limited to, cables, chains, or fasteners that are smaller in diameter than the diameter of the apertures in the first or second components. By sliding the obstruction item through the holes in the first and second components, when the security clasp is in the closed position, the item completes the obstruction system by obstructing the movement of the second component, thereby preventing the fastener from sliding to the open position. In other words, the obstruction item prevents the fastener from moving vertically out of the opening 26. Because the free leg 46 of the fastener 28 is maintained in the opening 26, it is incapable of rotationally moving.

By removing the obstruction item from the security clasp, the security clasp is left in its open state and free to move to the open position. In other words, by removing the obstruction item, the second component is free to move, allowing the fastener 28 to move vertically out of the opening 26. When the free leg of the fastener is moved vertically out of the opening 26, it becomes capable of rotational movement.

The present invention provides various advantages that are evident from the description above. For instance, the present invention has a limited number of moving parts, which reduces the changes of mechanical failure over the lifetime of the device. Moreover, fewer moving parts make manufacturing the present invention less costly and complicated. In addition, one aspect of the present invention does not include any internal moving parts, reducing the need for complicated manufacturing processes. Because there is no internal locking mechanism, one aspect of the present invention provides the advantage of allowing for securing two objects to one another without the use of a key or combination padlock.

One aspect of the present invention also includes a method for securing two devices to one another based on the exemplary aspects of the apparatus described above. According to the method of the present invention, the free leg 46 of fastener 28 is slipped into one part of a first object. Then, the free leg 46 is moved into the opening 26 of component 10. At this point, the guard plate 18 is in the “open” position, i.e., the flange 36 is not obstructing the opening 26. Once the free leg 46 is positioned in the opening 26, the guard plate 18 is rotated clockwise such that it is engaged with the lip 14 and groove 16. The security clasp can now be considered to be in the “closed” position because the flange 36 prevents the free leg 46 from being removed from opening 26. An obstruction item 40 may subsequently be inserted into the apertures of the guard plate 18 and the component 10 in order to prevent the guard plate 18 from being rotated counterclockwise, e.g., being removed from engagement with the lip 14 and groove 18.

In one aspect, this process may be repeated with multiple items so that several items can be secured to one another, as shown in FIG. 4. For instance, construction contractors are constantly faced with the proposition of the theft of their tools and other equipment. The exemplary apparatus of the present invention, including the obstruction item, may be used to lock the supplies of a construction contractors to one another, preventing theft. For instance, the present invention may be used to secure toolboxes, power-tool cases, cordless tools, power-tools, drills, saws, nailers, and combo kits.

Although various embodiments are described herein, the descriptions of various aspects of the present invention may be combined as desired. In other words, skilled artisans will understand that various embodiments may be combined in whole or in part. In addition, the description of aspects of the present invention includes various numerical ranges. The numerical ranges described herein may also be combined as desired. For instance, if a preferred embodiment describes a range of about 1 to about 10, it will also be understood that the preferred embodiment may be include between about 2 and about 10, about 3 and about 10. Similarly, it will also be understood that such a description will include aspects that include between about 1 and about 9, about 2 and about 8, and so on.

Although the invention has been explained in relation to its preferred embodiment(s) as mentioned above, it is to be understood that many other possible modifications and variations can be made without departing from the scope of the present invention.

What is claimed is:

1. A security clasp comprising:
a first component comprising a solid body including a first and second aperture, a lip, and a groove;
a second component including an aperture corresponding to the first aperture of the first component, the second component operatively connected to and slidingly engageable with the first component;
a third component comprising a first end movably connected to the first component and a second free end operable to be engaged with a second aperture formed in the first component;
wherein when the free end of the third component is positioned within the second aperture of the first component, and when the second component is engaged with the lip and the groove of the first component, a flange of the second component prevents the free end of the third component from being removed from the second aperture of the first component.

2. The security clasp of claim 1, wherein the second component further comprises a first aperture and a second aperture.

3. The security clasp of claim 2, wherein the center of the first aperture of the second component aligns with the center of the first aperture of the first component when the security clasp is in the closed position.

4. The security clasp of claim 3, wherein the first component is rectangular.

5. The security clasp of claim 3, wherein the first aperture of the first component and the first aperture of the second component are circular.

6. An apparatus, comprising:
a first component comprising a body having an aperture therein, the body also having a first receptacle formed in an outer edge of the body;
a second component operatively connected to the first component, the second component including a protrusion and an aperture substantially similar to the aperture in the body of the first component;
a third component comprising a first end that is housed within a portion of an inner cavity of the body of the first component, and a second end that is configured and dimensioned to fit within the first receptacle of the body of the first component;
wherein the protrusion of the second component obstructs the first receptacle of the body when the aperture of the second component is substantially aligned with the aperture of the body,

7. The apparatus of claim 6, wherein the first component further comprises a second receptacle operable to house a portion of the second component.

8. The apparatus of claim 6, further comprising an obstruction item operable to pass through the aperture of the first component and the aperture of the second component, wherein the obstruction item prevents movement of the second component when it is passed through the aperture of the first component and the aperture of the second component.

9. The apparatus of claim 6, wherein the first component is made out of a material selected from the list comprising metal, plastic, rubber, wood, alloys, nanomaterials, and combinations thereof.

10. The apparatus of claim 6, wherein the second end of the third component is operable to move within the first receptacle of the body when the protrusion obstructs the first receptacle of the body.

11. The apparatus of claim 7, wherein the second receptacle comprises a protrusion from the surface of the body.

12. The apparatus of claim 6, wherein the first end of the third component has a range of motion about at least one axis.

13. The apparatus of claim 6, wherein the third component comprises a “U” shape.

14. A security clasp comprising:
a first component, a second component, and a third component;
wherein the first component comprises a solid body with a first and second aperture, and a lip that extends in a parallel manner above the face of the first component;
wherein the second component comprises a solid guard plate with a first and second aperture movably connected to the exterior of the first component at the second aperture;
wherein the third component comprises a shackle movably connected to the first component;
wherein the security clasp is operable to be maintained in at least an open position and a closed position; and
wherein the first component further comprises an opening positioned to receive the free leg of the third component.

15. The security clasp of claim 14, wherein the second component at least partially covers the opening in the first component when the security clasp is in the closed position.

16. The security clasp of claim 14, wherein the diameter of first aperture of the guard plate and the diameter first aperture of the first component are between 1 centimeter and 20 centimeters.

17. The security clasp of claim 14, wherein the first component and the second component are both asymmetrical in shape.

18. The security clasp of claim 14, wherein the first aperture of the first component and the first aperture of the second component are circular.
